(19) United States
(12) Patent Application Publication
(10) Pub. No.: US 2012/0100502 A1
(43) Pub. Date: Apr. 26, 2012

(54) FLATBED DENTAL IMPLANT

(76) Inventor: Milan Djordjevic, Harare (ZW)

(21) Appl. No.: 13/279,047

(22) Filed: Oct. 21, 2011

Related U.S. Application Data
(60) Provisional application No. 61/405,428, filed on Oct. 21, 2010.

(51) Int. Cl. A61C 8/00

(52) U.S. Cl. 433/173

(57) ABSTRACT

The present invention is a flatbed dental implant to be utilized by a patient that includes a horizontal plate with a planar base with a thickness that has an elongated oval shape with a centered aperture and a perimeter with a thickness and a generally cylindrical body that is extended through the centered aperture of the horizontal plate forming a top portion and a bottom portion above the horizontal plate. The flatbed dental implant is a subcortical flatbed implant relevant to the patient's inferior alveolar nerve or the flatbed dental implant is a subcortical flatbed implant relevant to said patient's sinuses.

This application claims priority to U.S. Provisional Application 61/405,428 filed on Oct. 21, 2010, the entire disclosure of which is incorporated by reference.

### TECHNICAL FIELD & BACKGROUND

Dental implants are used to replace missing teeth and serve as support for placing and attaching a superstructure, which may be in the form of an abutment or an attachment. These dental implants are then used to attach teeth or dentures to the patient's jawbone. The most dental implants currently in use are an endosteal type of implant and are placed perpendicularly into the patient's jawbone, in an attempt to mimic the root of the lost tooth. The longer or wider the body of the implant, the more of the implant surface is engaged in supporting the superstructure. The problem which arises from using the standard endosteal approach is that in many cases, usually in the posterior region of the jaw, there is a possibility of damaging adjacent anatomical structures, primarily the maxillary sinus in the upper jaw or the inferior alveolar nerve in the lower jaw. Current surgical techniques address this problem by performing a sinus lift procedure or by avoiding or repositioning the nerve. Both procedures require superb surgical skills and experience, but may nevertheless result in complications.

Another type of implant used is of the sub periosteal type and is placed on top of the cortical bone just below the periosteum. This type of implant is substantially thinner than other implants so the width of the implant accounts for support and even distribution of force. The problem with the subperiosteal implants is that despite that they do not interfere with the anatomical structures they are not readily used. The reason for this is that these implants are deemed too complicated to manufacture, as they have to be customized to the patient's mouth and are not reliable, since they are not placed in the bone but rather on top of the bone as a one stage implant, consequently exposing the area to infection.

It is an object of the present invention to provide a flatbed dental implant that minimizes vertical penetration into the jawbone of the patient.

It is another object of the present invention is to provide a flatbed dental implant that increases a patient's bone and implant interface and support.

It is another object of the present invention is to provide a flatbed dental implant that adds a horizontal extension for additional support.

What is needed is a flatbed dental implant that minimizes vertical penetration into the jawbone of the patient, that increases a patient's bone and implant interface and support and that adds a horizontal extension for additional support.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side environmental view of a flatbed dental implant in a position of a subcortical flatbed implant relevant to a patient's sinus, in accordance with one embodiment of the present invention.

FIG. 1B illustrates a side environmental view of a flatbed dental implant in a position of a subcortical flatbed implant relevant to an inferior alveolar nerve, in accordance with one embodiment of the present invention.

FIG. 1C illustrates a side perspective view of a flatbed dental implant, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

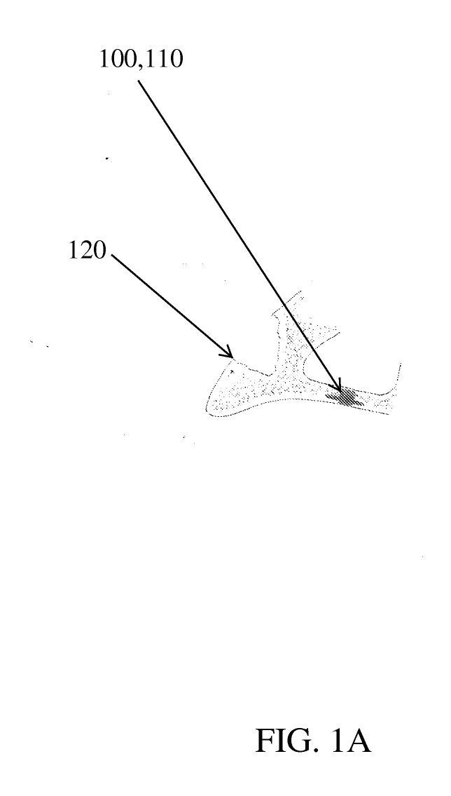

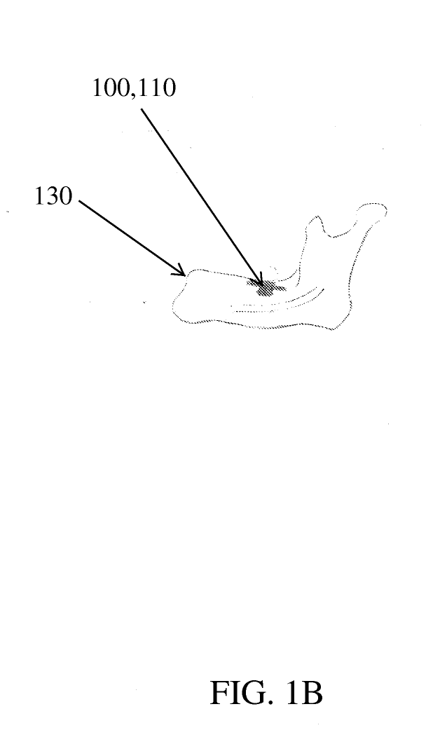

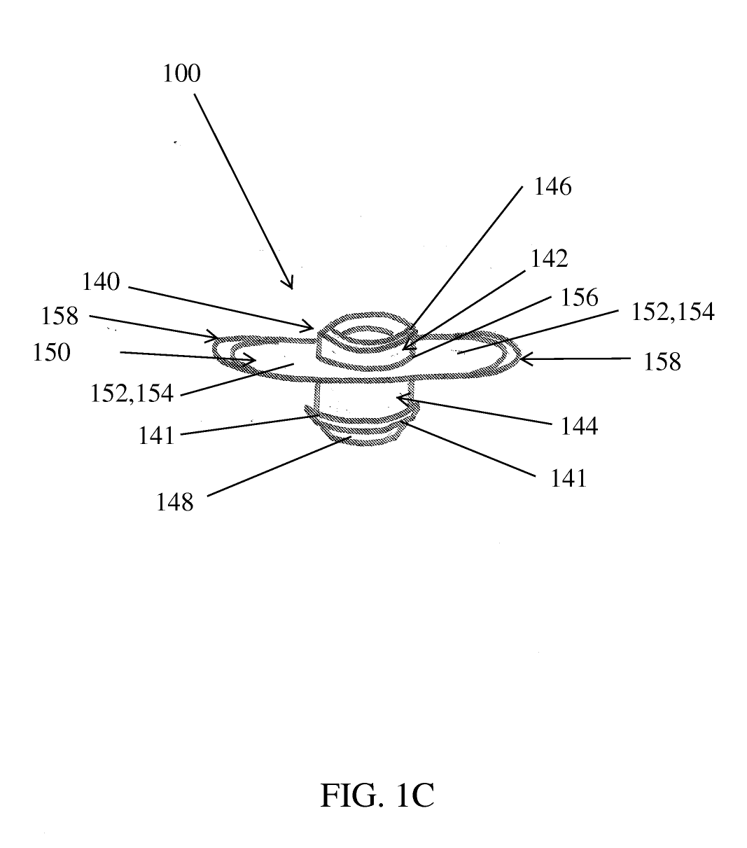

FIG. 1A illustrates a side environmental view of a flatbed dental implant 100 of a subcortical flatbed implant 110 relevant to a patient's sinuses 120, in accordance with one embodiment of the present invention.

The flatbed dental implant 100 is illustrated in a subcortical flatbed implant 110 position typically anywhere along a patient's subcortical flatbed implant 110, but can also be inserted in any suitable dental related position. Additional details regarding the flatbed dental implant 100 are described and illustrated in greater detail in FIG. 1C and its description.

FIG. 1B illustrates a side environmental view of a flatbed dental implant 100 of a subcortical flatbed implant 110 relevant to an inferior alveolar nerve 130, in accordance with one embodiment of the present invention.

The flatbed dental implant 100 is illustrated in a subcortical flatbed implant 110 position typically anywhere along a patient's subcortical flatbed implant 110, but can also be inserted in any suitable dental related position. Additional details regarding the flatbed dental implant 100 are described and illustrated in greater detail in FIG. 1C and its description.

FIG. 1C illustrates a side perspective view of a flatbed dental implant 100, in accordance with one embodiment of the present invention.

The flatbed dental implant 100 includes a generally cylindrical body 140 and a horizontal plate 150.

The generally cylindrical body 140 may be manufactured and made of titanium, zirconium dioxide or any other suitable material. The generally cylindrical body 140 has a diameter varying in the range of approximately 3 to 10 mm. This range is designed to accommodate the ranges of diameters associated with patient's different size mouths so that the flatbed dental implant 100 can be suitably inserted into. The generally cylindrical body 140 has a total height in the range of approximately 3 to 6 mm. This range is designed to accommodate the ranges of heights associated with patient's different size mouths that the flatbed dental implant 100 can be suitably inserted into. The generally cylindrical body 140 is extended through the horizontal plate 150 and forms a top portion 142 above the horizontal plate 150 and a bottom portion 144 below the horizontal plate 150. The top portion 142 can accommodate any suitable existing cylindrical type implant fixtures along with the corresponding attachment designs that may be used as a template for the generally cylindrical body 140 making the top portion 142 standard to any suitable manufacturer. The top portion 142 can also include one or more small rings 146 that are placed on the top portion 142, which provide additional stability to the generally cylindrical body 140.

The bottom portion 144 of the generally cylindrical body 140 extends downward from the horizontal plate 150. The bottom portion 144 has one or more flanges 141 that extend outward from the lower portion 148 of the bottom portion 144 of the generally cylindrical body 140. The flanges 141 provide additional strength in securing the flatbed dental implant 100 to the jawbone of the patient.

The horizontal plate 150 has a planar base 152 has an elongated oval shape 154 that includes a centered aperture 156 and a perimeter 158. The thickness of the horizontal plate 150 increases along the perimeter 158 to improve the horizontal plate 150 structural strength and allows for greater support when grafting the implant site. The centered aperture 156 vertically receives the generally cylindrical body 140 that runs through the centered aperture 156 forming the top portion 142 and the bottom portion 144.

The flatbed dental implant is a two stage subcortical/sub periosteal relatively shallow implant system that can be manufactured in standard prefabricated sizes. The flatbed dental implant is a relatively minimally invasive, safe and simple way of placing a well-supported shallow two stage implant in the posterior regions of the patient's jaw bones to minimize interference with adjacent anatomical structures achieved by placing and setting a horizontally supported low height, subcortical or flatbed dental implant.

The horizontal plate of the flatbed dental implant has variable length, width, thickness and angulation. The original design of the horizontal plate includes a thickened rim which becomes thicker further from the body of the implant. This provides for better structural strength of the horizontal plate, increases bone and implant interface and allows for support when grafting the site.

Other elements which include the flatbed dental implant may be adapted to and retrofit to existing suitable dental implant systems of different manufacturers.

The two stage subcortical/sub periosteal shallow implant system can be manufactured in standard prefabricated sizes to achieve a minimally invasive, safe and simple way of placing well supported relatively shallow two stage implants in the posterior regions of the jaws in order to minimize interference with adjacent anatomical structures. This is achieved by placing a horizontally supported low height subcortical or flatbed dental implant.

One suitable technique of implantation of the flatbed dental implant includes:

A) Site determination.

B) Anesthetizing the surrounding gums done by use of local anesthetic (infiltrative terminal anesthesia). Penetration of the implant into the bone is small, so block anesthesia is not deemed to be necessary.

C) Incision and exposure of the cortical bone by raising a mucoperiosteal flap of a size greater than the size of the horizontal plate of the implant.

D) Preparing the bed for the flat surface of the flatbed dental implant using the cortical bone stripper. The site for embedding the horizontal segment of the implant is predetermined by the shape, size and cutting depth of the cortical bone stripper. This flat circular instrument includes the cutting segment, which has the diameter corresponding to that of the implant body and the stopper which determines the depth of penetration and has a larger diameter. Standard saline irrigation is sufficient since the penetrating depth is small. This instrument may be designed and used as a rotational cutting instrument or a diamond piezo-surgical tip.

E) Verification of the size of the prepared bedding by use of a template which corresponds to the exact size of the horizontal plate. Drilling a guide for the implant body using a pilot drill is done by placing the pilot drill through the guide hole in the validator instrument.

F) Extending the pilot hole with the primary drill.

G) Finishing the preparation with a final drill.

H) Placing the implant in the prepared bedding using a plastic carrier. The carrier also serves as a support for gently knocking the implant into the prepared site. After completing the placement it is necessary to cover the entire site with bone grafting material.

I) The implant is then placed in the prepared bedding using a plastic carrier. This carrier also serves as a support for gently knocking the implant into the prepared site.

J) After completing the placement it is necessary to cover the entire site with bone grafting material.

K) Suturing to complete the implementation.

In addition to this procedure, a piezo-surgical burr could be used to perform the same procedure in a less complicated and less time consuming fashion. The shape and size of the working part of this diamond coated instrument correspond to that of the implant.

There are a number of other important features and benefits of the flatbed dental implant that include increasing the implant/bone surface contact and stability by adding a horizontal or angulated plate perpendicular to a standard, significantly shortened, cylinder type implant fixture. The horizontal plate design is also such that the thickness of its rim increases moving further from the body of the fixture. This provides for better structural strength of the plate, increases bone/implant interface, and allows for support when grafting the site. Use of a shorter implant fixture in order to decrease depth of bone penetration can also be done. The body of the fixture has on the circumference of the apical third one or more rings incorporated into it in order to provide for better primary stability.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed:

1. A flatbed dental implant to be utilized by a patient, comprising:
a horizontal plate that includes a planar base with a thickness that has an elongated oval shape with a centered aperture and a perimeter with a thickness; and
a generally cylindrical body that is extended through said centered aperture of said horizontal plate forming a top portion and a bottom portion above said horizontal plate.

2. The implant according to claim 1, wherein said flatbed dental implant is a subcortical flatbed implant relevant to said patient's sinuses.

3. The implant according to claim 1, wherein said flatbed dental implant is made of titanium.

4. The implant according to claim 1, wherein said flatbed dental implant is made of zirconium oxide.

5. The implant according to claim 1, wherein said thickness of said perimeter has a greater thickness than said thickness of said planar base to allow additional structural strength.

6. The implant according to claim 1, wherein said centered aperture vertically receives said generally cylindrical body that runs through said centered aperture forming said top portion and said bottom portion.

7. The implant according to claim 1, wherein said generally cylindrical body has a diameter in the range of approximately 3 to 10 mms to accommodate a plurality of different patient mouth sizes.

8. The implant according to claim 1, wherein said generally cylindrical body has a height in the range of approximately 3 to 6 mms to accommodate a plurality of different patient mouth sizes.

9. The implant according to claim 1, wherein said top portion includes one or more small rings that are placed on said top portion to provide additional stability to said generally cylindrical body.

10. The implant according to claim 1, wherein said bottom portion has one or more flanges that extend outward to provide additional strength in securing said flatbed dental implant.

11. A flatbed dental implant to be utilized by a patient, comprising:
a horizontal plate that includes a planar base with a thickness that has an elongated oval shape with a centered aperture and a perimeter with a thickness; and
a generally cylindrical body that is extended through said centered aperture of said horizontal plate forming a top portion and a bottom portion above said horizontal plate.

12. The implant according to claim 11, wherein said flatbed dental implant is a subcortical flatbed implant relevant to said patient's inferior alveolar nerve.

13. The implant according to claim 11, wherein said flatbed dental implant is made of titanium.

14. The implant according to claim 11, wherein said flatbed dental implant is made of zirconium oxide.

15. The implant according to claim 11, wherein said thickness of said perimeter has a greater thickness than said thickness of said planar base to allow additional structural strength.

16. The implant according to claim 11, wherein said centered aperture vertically receives said generally cylindrical body that runs through said centered aperture forming said top portion and said bottom portion.

17. The implant according to claim 11, wherein said generally cylindrical body has a diameter in the range of approximately 3 to 10 mms to accommodate a plurality of different patient mouth sizes.

18. The implant according to claim 11, wherein said generally cylindrical body has a height in the range of approximately 3 to 6 mms to accommodate a plurality of different patient mouth sizes.

19. The implant according to claim 11, wherein said top portion includes one or more small rings that are placed on said top portion to provide additional stability to said generally cylindrical body.

20. The implant according to claim 11, wherein said bottom portion has one or more flanges that extend outward to provide additional strength in securing said flatbed dental implant.
